(19) United States
(12) Patent Application Publication
(10) Pub. No.: US 2006/0042664 A1
(43) Pub. Date: Mar. 2, 2006

(54) Apparatus and method for removing a liquid from a rotating substrate surface

(76) Inventors: Vishwas Hardikar, Phoenix, AZ (US); Chris Karlsrud, Chandler, AZ (US); Tom Le, Chandler, AZ (US)

Correspondence Address: INGRASSIA FISHER & LORENZ, P.C., 7150 E. CAMELBACK, STE. 325, SCOTTSDALE, AZ, 85251, US

(21) Appl. No.: 10/930,290

(22) Filed: Aug. 30, 2004

(51) Int. Cl. B08B 5/00; B08B 1/02; B08B 7/00; B08B 3/00

(52) U.S. Cl. 134/31; 134/32; 134/33; 134/34; 134/902; 134/148; 134/153

(57) ABSTRACT

An apparatus and method for performing a rinsing process on a workpiece surface, the apparatus including a platform adapted to seat the workpiece thereon, a chuck connected to the platform and adapted to spin the workpiece during the rinsing process, a mechanical arm adapted to sweep across at least part of the workpiece surface during the rinsing process, first and second rinsing liquid nozzles secured to the mechanical arm, a tensioactive vapor nozzle secured to the arm and disposed between the first and second rinsing liquid nozzles, and first and second flow control elements adapted to separately and independently control rinsing liquid flow rates for the first and second rinsing liquid nozzles, respectively.

### TECHNICAL FIELD

The present invention generally relates to an apparatus and method for removing a processing or rinsing liquid from a rotating substrate surface, and more particularly relates to an apparatus and method for removing such a liquid without allowing particles in the liquid to settle on the surface due to liquid evaporation or streaking.

### BACKGROUND

During a typical semiconductor wafer fabrication process it is necessary to subject the wafer to a plurality of cleaning steps. Etching compounds, polishes, solvents, and other chemicals used for deposition or polishing methods often leave residues on the wafer. Such compounds must typically be rinsed or otherwise removed to free the wafer of contaminants. An effective wafer cleaning includes a quick drying process. Many benefits gained by an effective rinsing step can be lost if the drying step is not carefully carried out.

One common method for cleaning a semiconductor wafer is spin rinse drying, which involves mounting a wafer on a chuck and spraying the wafer with a cleaning solvent while the wafer is spinning. A desirable feature of spin rinse drying is the ability to dry each wafer individually and not in batches. Integrated circuits are commonly manufactured individually, with processing steps including implantation, deposition, etching, etc. performed on one substrate at a time. Spin rinse drying allows for the cleaning processes to be performed in line with the other processing steps, removing the need to wait for a certain number of wafers to be ready for combined cleaning.

Some spin rinse drying processes utilize the wind created during spinning to dry the cleaning liquid. Air-drying the wafer surface in this manner is somewhat counterproductive because particulates that were dissolved in the liquid will remain on the wafer surface after the liquid evaporates. Also, streak marks are often left on the wafer surface when drying is performed in this manner. The wafer outer regions spin with a greater velocity than the wafer inner regions, and the wafer outer regions are consequently the first areas to dry. When a rotational force causes liquid to spread from the wafer inner areas over the dry outer surface, particulates in the liquid will sometimes create the streak mark.

One improved spin rinse drying apparatus is illustrated in FIG. 1. A wafer 10 rotates at a speed co while a liquid 16 is delivered to the wafer surface through a dispense tube 12 that slowly moves from the substrate center towards the edge at a speed v. A second nozzle 14 is mounted on the trailing side of the liquid dispense tube 12. The second nozzle 14 dispenses a tensioactive vapor that reduces the liquid surface tension and creates a strong force, commonly referred to as the Marangoni force, tangential to the wafer surface. The interaction of the rotational force with the Marangoni force physically removes the liquid from the wafer surface instead of allowing the liquid to evaporate.

Although the method described above combining the Marangoni force with rotational force provides a cleaner wafer than a conventional spin drying process, there are still some inherent limitations that impede the production of a wafer that is substantially free of streak marks or other particulate residue. One such limitation is the tendency for some drying to still occur at the wafer outer periphery before the inner areas are completely rinsed and dried. The wafer outer periphery still dries due to liquid evaporation while inner wafer areas are being physically dried by the forces produced by the tensioactive vapor and the rotating wafer. Particulate residue from the evaporated liquid is not easily removed, even using the combined tensioactive vapor and rinsing liquid.

Accordingly, it is desirable to provide a rinsing and drying apparatus and method that enable removal of rinsing liquid and the particulates dissolved therein at the same time. In addition, it is desirable to provide a rinsing and drying apparatus and method that produces a wafer or other workpiece substantially free of particulates due to liquid streaking or evaporation residue. Furthermore, other desirable features and characteristics of the present invention will become apparent from the subsequent detailed description and the appended claims, taken in conjunction with the accompanying drawings and the foregoing technical field and background.

### BRIEF SUMMARY

According to one embodiment of the invention, an apparatus is provided for performing a rinsing process on a workpiece surface. The apparatus comprises a platform adapted to seat the workpiece thereon, a chuck connected to the platform and adapted to spin the workpiece during the rinsing process, a mechanical arm adapted to sweep across at least part of the workpiece surface during the rinsing process, first and second rinsing liquid nozzles secured to the mechanical arm, a tensioactive vapor nozzle secured to the arm and disposed between the first and second rinsing liquid nozzles, and first and second flow control elements adapted to separately and independently control rinsing liquid flow rates for the first and second rinsing liquid nozzles, respectively.

According to another embodiment of the invention, an apparatus for performing a rinsing process on a workpiece surface comprises a platform adapted to seat the workpiece thereon, a chuck connected to the platform and adapted to spin the workpiece during the rinsing process, a mechanical arm adapted to sweep across at least part of the workpiece surface during the rinsing process, first and second rinsing liquid nozzles secured to the mechanical arm, at least one rinsing liquid source supplying the first and second rinsing liquid nozzles, a tensioactive vapor nozzle secured to the arm and disposed between the first and second rinsing liquid nozzles, and, a tensioactive vapor source supplying the tensioactive vapor nozzle with a composition that, when mixed with the rinsing liquid, reduces the rinsing liquid surface tension on the workpiece surface.

According to another embodiment of the invention, a method for rinsing a workpiece surface is provided. The method comprises the steps of dispensing a rinsing liquid onto the workpiece surface using first and second rinsing nozzles while sweeping the rinsing nozzles over at least part of the workpiece surface, separately and independently controlling rinsing liquid flow rates for each of the first and second rinsing nozzles, and spraying a tensioactive vapor composition onto an area of the workpiece surface that is simultaneously being rinsed by the first rinsing nozzle.

According to another embodiment of the invention, a method for rinsing a workpiece surface comprises the steps of dispensing a rinsing liquid onto the workpiece surface using first and second rinsing nozzles while sweeping the rinsing nozzles over at least part of the workpiece surface, and using a nozzle that is disposed between the rinsing nozzles, spraying a tensioactive vapor composition onto an area of the workpiece surface that is simultaneously being rinsed by the first rinsing nozzle.

### BRIEF DESCRIPTION OF THE DRAWINGS

The present invention will hereinafter be described in conjunction with the following drawing figures, wherein like numerals denote like elements, and

FIG. 1(a) is a cross sectional view of a conventional spin rinse apparatus that utilizes a rinsing liquid along with a tensioactive vapor to clean a workpiece;

FIG. 1(b) is a top view of the apparatus illustrated in FIG. 1(a);

FIG. 2 is a perspective view of a cleaner module that includes one or more cleaning machines including a spin rinse apparatus according to the present invention;

FIG. 3 is a top view of a spin rinse apparatus at the beginning of a cleaning process according to an embodiment of the present invention;

FIG. 4 is a top view of a spin rinse apparatus at the end of a cleaning process according to an embodiment of the present invention

FIG. 5 is a perspective view of a nozzle assembly according to an embodiment of the present invention, with the nozzle assembly mounted on an automated arm;

FIG. 6 is a perspective view of the nozzle assembly with the nozzle dispensing ends pointed in directions for thoroughly cleaning a workpiece surface according to an embodiment of the invention;

FIGS. 7a-c are, respectively, a perspective view, a side view, and a bottom view of a vapor nozzle for use with a spin rinse apparatus according to an embodiment of the present invention;

FIGS. 8a-c are, respectively, a perspective view, a side view, and a top view of a first liquid nozzle for use with a spin rinse apparatus according to an embodiment of the present invention; and

FIGS. 9a-c are, respectively, a perspective view, a side views differing by 90° of a second liquid nozzle for use with a spin rinse apparatus according to an embodiment of the present invention.

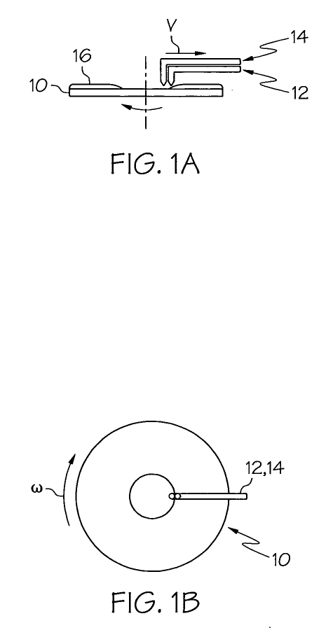

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The apparatus and method of the present invention accomplish the task of effectively removing a rinsing liquid and the particulates dissolved therein from a workpiece such as a semiconductor wafer, and consequently produce a workpiece surface that is substantially free of particulate residue. The apparatus and method-of the present invention has proven to be particularly effective at removing a rinsing liquid from a workpiece having a hydrophobic surface despite the high susceptibility that hydrophobic surfaces have to streaking. The workpiece surface is cleaned using a spin rinse apparatus that incorporates a plurality of rinsing liquid nozzles to thoroughly wet the workpiece surface, and a tensioactive vapor nozzle to create a Maragoni force that drives the rinsing liquid off of the workpiece surface. The nozzle arrangement and the manner in which the nozzles are controlled to adapt to particular workpieces prevents particulate residue due to evaporation or liquid streaking on the workpiece surface.

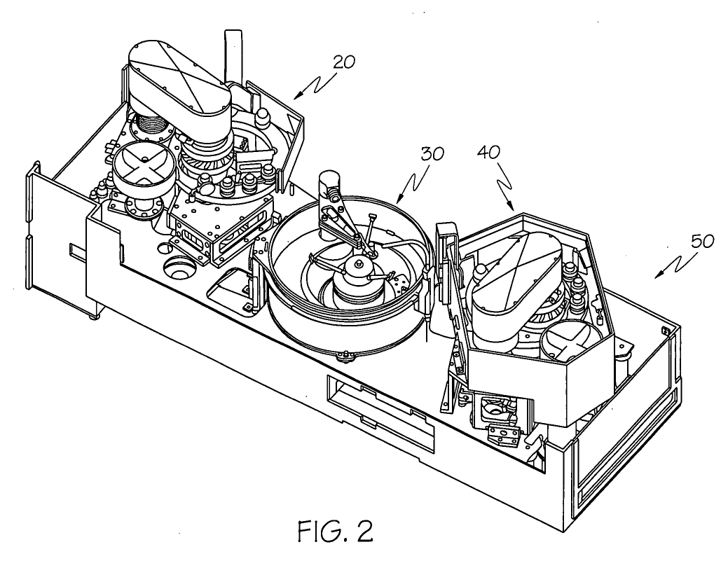

FIG. 2 illustrates a workpiece cleaning module 50 that includes a plurality of cleaners 20, 30, 40. According to one embodiment of the invention the cleaners 20, 30, 40 in FIG. 2 are all non-contact cleaners, meaning that the cleaners do not use brushes, pads, or other mechanical devices to contact a workpiece during cleaning. It is of course within the scope of the present invention to use both non-contact and contact cleaners as components of the cleaning module 50 as needed. It is also within the scope of the present invention to use non-contact cleaners that are different than the non-contact cleaners 20, 30, 40 illustrated in FIG. 2 and described herein. In an exemplary embodiment, each of the cleaners 20, 30, 40 includes a chuck for rotating a workpiece, and an arm on which various cleaning instruments are installed. One cleaner 20 can be a conventional brush scrubbing apparatus in the event that a user wishes for some cleaning to be performed using brush cleaners. Another cleaner 30 can be a megasonic cleaning apparatus. At least one cleaner 40 is an apparatus that combines Marangoni force with rotational force to rinse and clean a workpiece.

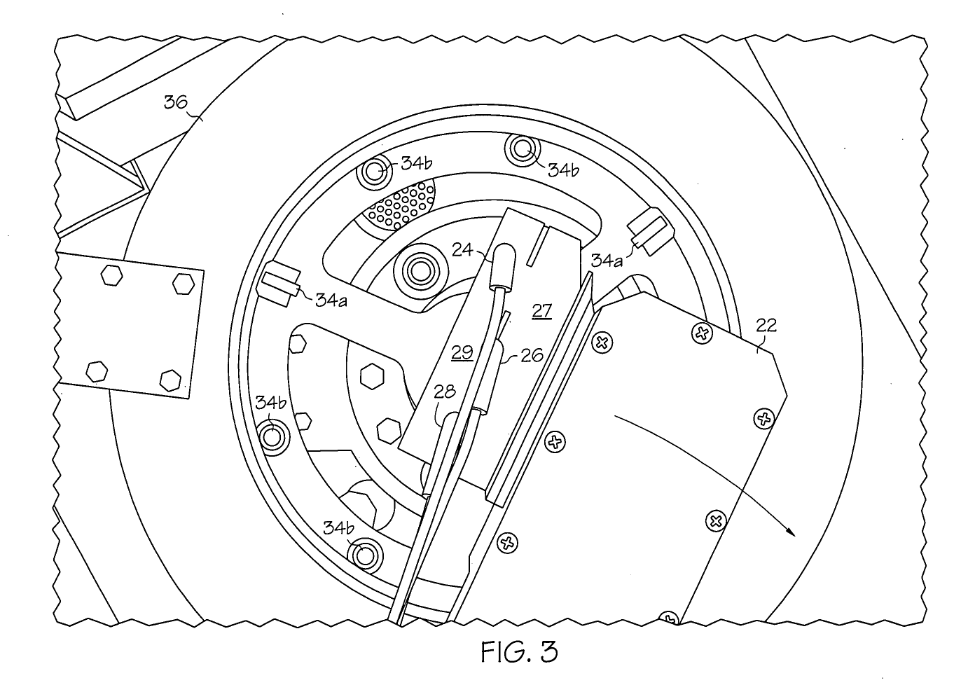

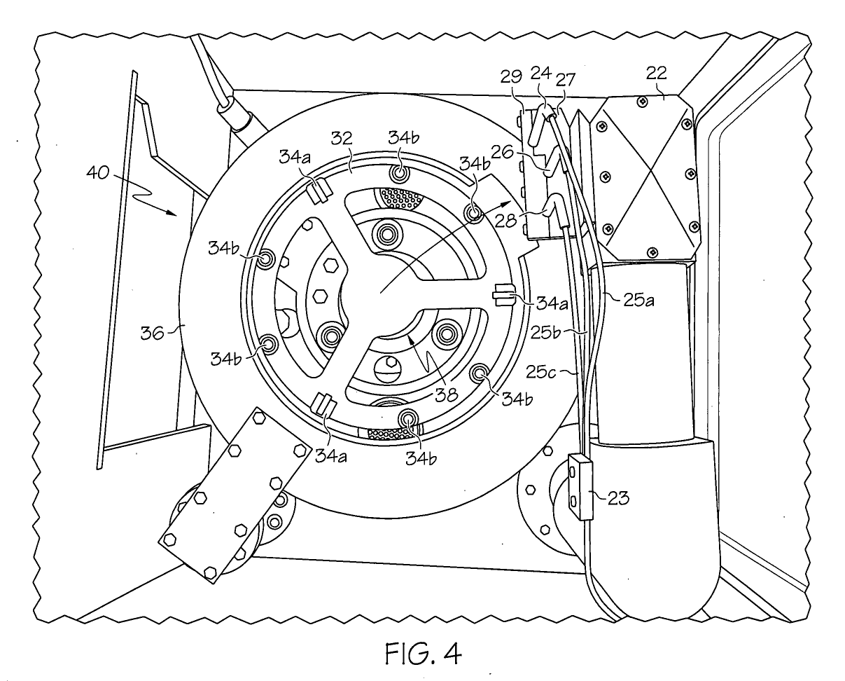

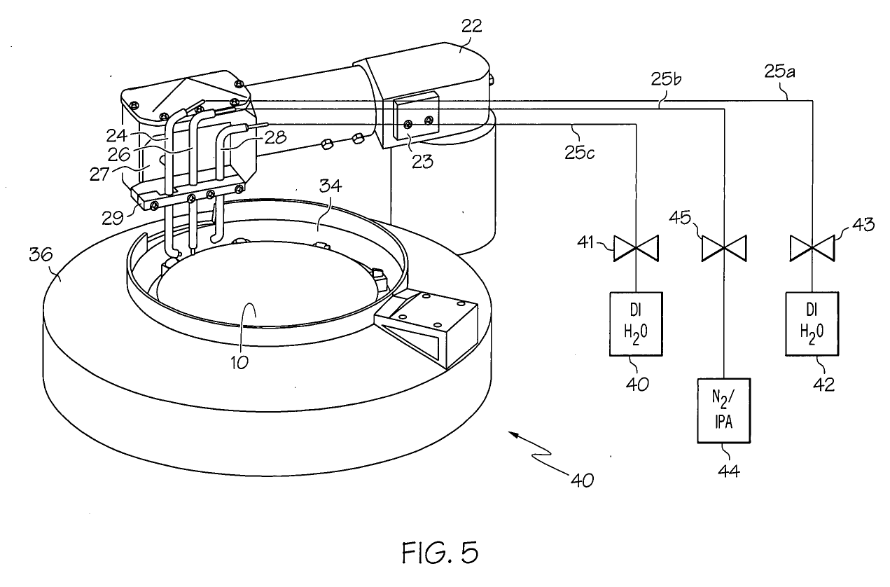

Top views of a workpiece cleaner 40 according to an exemplary embodiment of the invention are illustrated in FIGS. 3 and 4, with an arm 22 and nozzles 24, 26, 28 secured thereto positioned at a starting point of a cleaning process in FIG. 3, and at an ending point of the cleaning process in FIG. 4. A perspective view of the workpiece cleaner 40 is provided in FIG. 5 to more clearly illustrate the relationship between the cleaner 40 and a workpiece 10 to be cleaned. The cleaner 40 includes a workpiece supporting mechanism that includes a platform 32 and a chuck 38 upon which the platform 32 is mounted. The platform 32 is equipped with wafer stabilizing members 34a that are arranged to closely surround the workpiece periphery and counter during a workpiece cleaning process. The stabilizing members 34a have a tapered end for guiding the workpiece 10 to a seated position at which at least three of the stabilizing members 34a secure the workpiece in place. Additional stabilizing members provide additional lateral support for the workpiece and can be added as needed.

The cleaner 40 also includes a cleaning fluid distribution mechanism that includes fluid hoses 25a-c, nozzles 24, 26, 28 that distribute fluid from the hoses 25a-c, and an arm 22 that secures the nozzles 24, 26, 28 and sweeps them along an arc between the workpiece center and the outer edge during a cleaning process. In an exemplary embodiment, the sweeping motion for the arm is controlled independently with respect to the rotation of the chuck 38 and the platform 32 mounted thereon in order to optimize the nozzle positions above the workpiece 10 and to independently optimize the rate at which the workpiece 10 is rotated.

Each of the hoses 25a-c is connected to a different fluid supply source. The first hose 25a connects the first nozzle 24 with a DI water source 40. The second hose 25b connects the second nozzle 26 with a dry tensioactive vapor gas source 44. The third hose 25c connects the third nozzle 28 with a DI water source 42 that is separate from the first DI water source 40. Alternatively, the DI water sources 40, 42 are a single container, although an important feature of the invention as described in detail below is the ability to separately control the flow rates and pressures for the DI water supplied to each of the two rinsing nozzles 24, 28. A bracket 23 located at one end of the arm 22 secures the fluid hoses 25a-c to prevent tangling and to substantially eliminate the potential for the hoses 25a-c to be subjected to a tension force as the arm moves. A second bracket 27 is located at an opposite end of the arm positions the nozzles 24, 26, 28 and directs their streams toward specific workpiece areas during a cleaning process. A clamp 29 secures the nozzles 24, 26, 28 to the bracket 27.

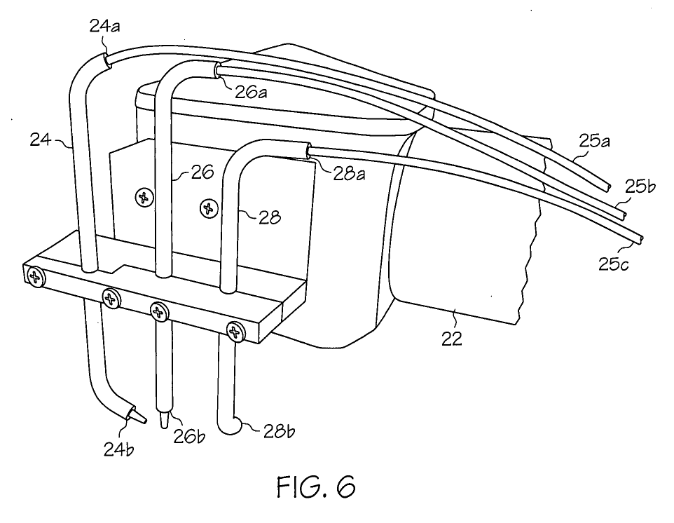

The arced arrows in FIGS. 3 and 4 represent the manner in which the arm 22 sweeps the nozzles 24, 26, 28 along an arc that traverses the workpiece radius during a cleaning process, beginning in the vicinity of the workpiece center and moving outwardly toward the workpiece edge. FIG. 6 illustrates the manner in which each nozzle 24, 26, 28 is positioned on the arm 22 to thoroughly rinse and dry the workpiece 10. Two nozzles 24, 28 are rinsing nozzles that dispense DI water onto the workpiece 10 at particular angles and in particular directions. Consequently, the streams dispensed from the rinsing nozzles 24, 28 are directional, laminar streams in an exemplary embodiment of the invention, although it is within the scope of the invention for the streams from the rinsing nozzles 24, 28 to be turbulent sprays as well.

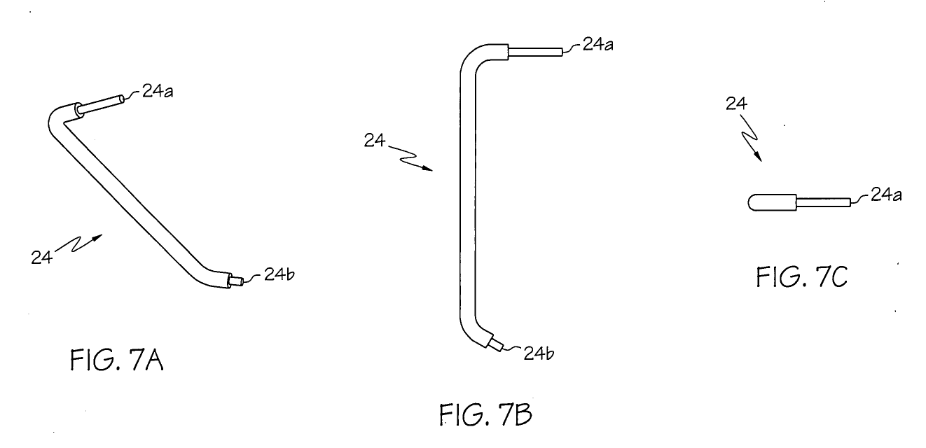

The most outwardly positioned nozzle on the arm 22 is a first DI water nozzle 24. FIGS. 7a-c are perspective, side, and top views of the first DI water nozzle 24. The nozzle 24 attaches at one end 24a to a DI water hose 25a. The nozzle dispensing end 24b is bent or otherwise disposed at an angle with respect to a vertical plane in order to direct DI water onto the workpiece 10 at an acute angle with respect to the horizontally disposed workpiece surface being cleaned. From FIG. 6 it can be seen that at the start of the cleaning process the DI water is dispensed onto the workpiece center. In an exemplary embodiment, the nozzle dispensing end 24b is bent or otherwise positioned to dispense the DI water at an angle of about 120° from a vertical plane when the workpiece 10 is spinning on a horizontal plane; or in other words, the nozzle dispensing end 24b dispenses the DI water at about a 60° angle with respect to the workpiece surface being cleaned.

In addition to DI water, other aqueous rinsing liquids can be utilized to rinse the workpiece 10 using the nozzle 24 and also the second rinsing nozzle 28, described in detail below. For example, the rinsing liquid can include a surfactant to decrease the surface tension between the rinsing liquid and the workpiece surface. A surfactant is particularly advantageous when rinsing a hydrophobic surface since DI water is particularly prone to streaking if there is little surface tension with the workpiece surface. In an exemplary embodiment of the invention a nonionic surfactant is included in the rinsing liquid.

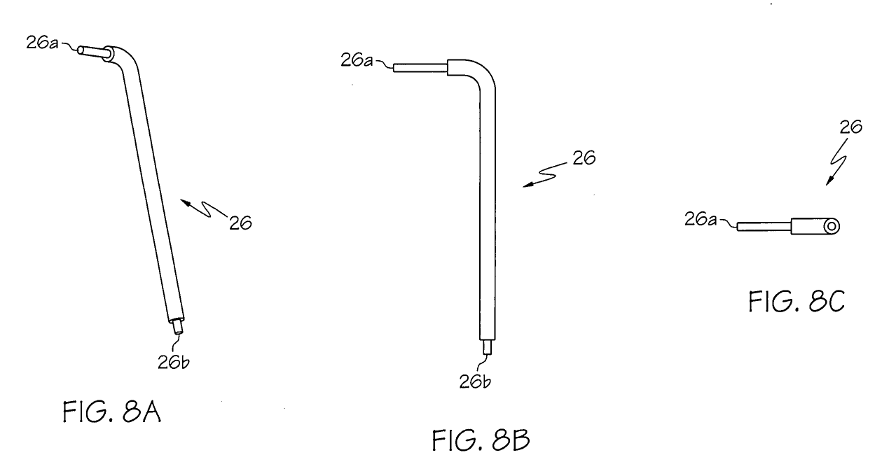

FIGS. 8a-c are perspective, side, and bottom views of a tensioactive vapor spraying nozzle 26 that is positioned inwardly on the arm 22 with respect to the DI water nozzle 24. The nozzle 26 is attached at one end 26a to a tensioactive vapor hose 25b.

A spraying end 26b sprays a substantially dry gas that includes a vaporized tensioactive compound. In one embodiment of the invention the nozzle 26 sprays approximately <1% isopropyl alcohol (IPA) vaporized in a nitrogen gas stream. Other tensioactive compounds can be vaporized and sprayed in a carrier gas, with exemplary tensioactive compounds include one or more selected from ethyl acetate, acetone, and diacetone alcohol. The IPA or other tensioactive fluid concentration can be modified to meet the requirements of a particular rinsing process as long as the compound is miscible with the rinsing liquid and, when mixed with the rinsing liquid, yields a mixture having a surface tension that is lower than that of the rinsing liquid by itself.

The spraying end 26b directs the tensioactive vapor onto the workpiece surface at a substantially perpendicular angle in an exemplary embodiment of the invention. From FIG. 6 it can be seen that at the start of the cleaning process the nozzle 26 sprays the tensioactive vapor onto the workpiece center. The tensioactive vapor immediately forces rinsing liquid from the area being sprayed with the dry vapor, creating a circular liquid-vapor boundary as the workpiece 10 rotates. The workpiece 10 is completely dry inside the circle created by the liquid-vapor boundary, and the circle increases in diameter as the tensioactive vapor spraying nozzle 26 moves toward the workpiece outer edge until the workpiece 10 is completely dried.

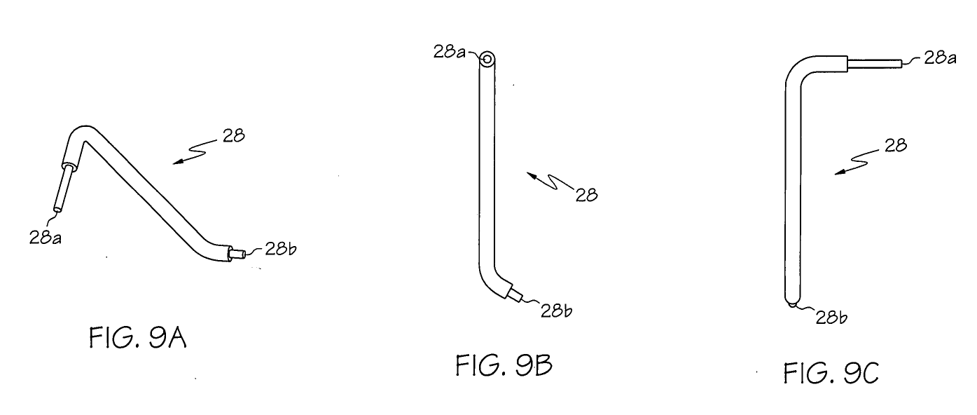

FIGS. 9a-b are perspective and side views of a second DI water dispensing nozzle 28. FIG. 9c is a side view of the nozzle 28 rotated 90° from the position illustrated in FIG. 9b. The second DI water nozzle 28 is positioned inwardly on the arm 22 with respect to the first DI water nozzle 24 and the tensioactive vapor spraying nozzle 26. The nozzle 28 attaches at one end 28a to a DI water hose 25c that is supplied and controlled entirely separate from the DI water hose 25a that supplies the first DI water nozzle 24.

The second DI water nozzle 28 is provided to wet the workpiece surface between the workpiece outer surface and the liquid-vapor boundary established by the two other nozzles 24, 26. The second DI water nozzle dispensing end 28b is bent at an angle with respect to a vertical plane in order to direct DI water onto the horizontally disposed workpiece 10 in an outward direction. From FIG. 6 it can be seen that at the start of the cleaning process the DI water from the second DI water nozzle 28 is dispensed toward the workpiece outer edge, beginning at a position that is closer to the workpiece outer edge than the stream from the first DI water nozzle 24. In an exemplary embodiment, the nozzle dispensing end 28b is bent or otherwise positioned to dispense at an angle of about 120° from a vertical plane when the workpiece 10 is spinning on a horizontal plane; or in other words, the nozzle dispensing end 28b dispenses the DI water at about a 60° angle with respect to the workpiece surface. The first DI water nozzle 24 also dispenses the workpiece surface at about a 60° angle, but is pointed toward the workpiece center at the beginning of the cleaning process. The second DI water nozzle is pointed toward the workpiece outer edge, and the directions in which the nozzles 24, 28 are pointed in a horizontal plane preferably differ by approximately 90°. Consequently, the second DI water nozzle 28 is always dispensing an area that is closer to the closest workpiece outer edge than the area being rinsed by the first DI water nozzle 24, and therefore prevents streaking from occurring near the workpiece outer edge.

As mentioned above, one of the advantages of the present invention comes from having the first DI water nozzle 24 and the second DI water nozzle 28 separately supplied and/or controlled. In one exemplary embodiment of the invention, each of the DI water nozzles 24, 28 is supplied by separate DI water sources 40, 42, allowing the water flow rate in the second DI water nozzle 28 to be increased or decreased as needed to thoroughly wet the wafer periphery without affecting the flow rate and the rinsing process for the first DI water nozzle 24. Alternatively, the DI water sources 40, 42 are a single container. In either case, the rinsing liquid flow rates for each of the DI water nozzles 24, 28 are separately and independently controlled using valves 41, 43 or other flow control elements such as pressure regulators. Further, each DI nozzle 24, 28 is separately secured to the arm 22 using the clamp 27 and bracket 29, so the distances between the DI water nozzle dispensing ends 24a, 28a and the workpiece surface can be individually adjusted as necessary.

As mentioned previously while describing the first DI nozzle 24, other aqueous rinsing liquids can be utilized to rinse the workpiece 10 using the second DI nozzle 28, such as a surfactant to decrease the surface tension between the rinsing liquid and the workpiece surface. In an exemplary embodiment of the invention a nonionic surfactant is included in the rinsing liquid.

Also, in another embodiment of the invention, less than all of the nozzles 24, 26, 28 are mounted on the arm 22. For example, only one or both of the DI nozzles 24, 28 are mounted on the arm 22 according to one embodiment, and the motion of the arm and the nozzles mounted thereon is controlled independently with respect to the motion of the tensioactive vapor spraying nozzle 26 which is mounted on a separate arm or other device that sweeps above the workpiece surface. Further, each of the nozzles 24, 26, 28 can be moved at independent rates and in independent directions by mounting each on different arms or other devices that sweep above the workpiece surface.

Conditions for an exemplary cleaning process utilizing the two DI water nozzles 24, 28 and the tensioactive vapor spraying nozzle 26 will now be described. Each nozzle dispensing or spraying end 24a, 26a, 28a is positioned between about 5 mm and about 10 mm from a workpiece surface, and preferably between about 5 mm and about 7 mm from the workpiece surface. During the cleaning process the workpiece spins at a rate of about 200 to about 1000 rpm, preferably between about 200 and about 300 rpm. Once the workpiece 10 is spinning at a predetermined rate, the flow rate for each of the DI water nozzles 24, 28 is set between about 155 ml/min and about 175 ml/min at a pressure of approximately 30 psi. The workpiece is dried and substantially free of streaking or particulate residue when the flow rate from the tensioactive vapor spraying nozzle 26 is up to about 3 L/min, and preferably approximately 2 L/min with the pressure set at approximately 30 psi.

As the nozzles 24, 26, 28 are swept along an arc over the workpiece 10, the distance between the center of the tensioactive vapor spray and either of the DI water streams is between about 5 mm and about 7 mm, although the first DI water nozzle 24 is directed toward the center of the tensioactive vapor spray while the second DI water nozzle 28 is directed away from the center of the tensioactive vapor spray, and preferably dispenses at angle that differs from that of the first DI water nozzle 24 in a horizontal plane by approximately 90°. The tensioactive vapor spray nozzle 26 dispenses a tensioactive vapor, such as approximately <1% IPA in N₂, and the tensioactive vapor reduces the liquid surface tension and creates a Marangoni force tangential to the wafer surface. The interaction of the rotational force with the Marangoni force physically removes the liquid from the wafer surface instead of allowing the liquid to evaporate. At the end of the cleaning process, the second DI water nozzle 28 is closed as the stream therefrom passes over the workpiece outer edge. The stream from the first DI water nozzle 24 then passes over the workpiece outer edge and the nozzle 24 is closed. The tensioactive vapor spray nozzle 26 continues to dry the workpiece 10 until the nozzle 26 passes over the workpiece outer edge, producing a workpiece that is dried and substantially free of streaking or particulate residue.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An apparatus for performing a rinsing process on a workpiece surface, comprising:
a platform adapted to seat the workpiece thereon;
a chuck connected to the platform and adapted to spin the workpiece during the rinsing process;
a mechanical arm having a first end, the arm being adapted to sweep the first end across at least part of the workpiece surface during the rinsing process;
first and second rinsing liquid nozzles secured to the mechanical arm first end;
a tensioactive vapor nozzle secured to the mechanical arm first end and disposed between the first and second rinsing liquid nozzles; and
first and second flow control elements adapted to separately and independently control rinsing liquid flow rates for the first and second rinsing liquid nozzles, respectively.

2. The apparatus according to claim 1, further comprising at least one rinsing liquid source supplying the first and second rinsing liquid nozzles.

3. The apparatus according to claim 2, wherein first and second rinsing liquid sources separately and independently supply the first and second rinsing liquid nozzles, respectively.

4. The apparatus according to claim 2, wherein the rinsing liquid in the rinsing liquid source comprises DI water.

5. The apparatus according to claim 4, wherein the rinsing liquid further comprises a surfactant that, when mixed with the rinsing liquid, decreases the rinsing liquid surface tension on a hydrophobic surface.

6. The apparatus according to claim 1, further comprising a tensioactive vapor source supplying the tensioactive vapor nozzle with a composition that, when mixed with the rinsing liquid, reduces the rinsing liquid surface tension on the workpiece surface.

7. The apparatus according to claim 6, wherein the tensioactive vapor in the tensioactive vapor source is nitrogen gas mixed with isopropyl alcohol vapor.

8. The apparatus according to claim 1, wherein the mechanical arm is adapted to sweep in an arc over the workpiece surface during the rinsing process.

9. The apparatus according to claim 1, wherein the second rinsing liquid nozzle is positioned to always dispense nearer to a closest workpiece outer edge than the first rinsing liquid nozzle during the rinsing process.

10. The apparatus according to claim 1, wherein the first rinsing liquid nozzle is the most outwardly positioned nozzle on the mechanical arm and the second rinsing liquid nozzle is the most inwardly positioned nozzle on the mechanical arm.

11. The apparatus according to claim 10, wherein the first rinsing liquid nozzle is positioned to dispense toward an area where the tensioactive vapor nozzle sprays the workpiece during the rinsing process.

12. The apparatus according to claim 11, wherein the tensioactive vapor nozzle is positioned to spray the workpiece at a substantially perpendicular angle with respect to the workpiece surface during the rinsing process.

13. The apparatus according to claim 11, wherein the second rinsing liquid nozzle is positioned to dispense toward an outer edge of the workpiece during the rinsing process.

14. The apparatus according to claim 13, wherein the first and second rinsing liquid nozzles are pointed in directions that in a horizontal plane differ by approximately 90°.

15. The apparatus according to claim 1, wherein the chuck is adapted to have spinning parameters that are controlled independent of any motion parameters for the mechanical arm.

16. An apparatus for performing a rinsing process on a workpiece surface, comprising:
a platform adapted to seat the workpiece thereon;
a chuck connected to the platform and adapted to spin the workpiece during the rinsing process;
a mechanical arm having a first end, the mechanical arm being adapted to sweep across at least part of the workpiece surface during the rinsing process;
first and second rinsing liquid nozzles secured to the mechanical arm first end;
at least one rinsing liquid source supplying the first and second rinsing liquid nozzles;
a tensioactive vapor nozzle secured to the mechanical arm first end and disposed between the first and second rinsing liquid nozzles; and
a tensioactive vapor source supplying the tensioactive vapor nozzle with a composition that, when mixed with the rinsing liquid, reduces the rinsing liquid surface tension on the workpiece surface.

17. The apparatus according to claim 16, wherein first and second rinsing liquid sources separately and independently supply the first and second rinsing liquid nozzles, respectively.

18. The apparatus according to claim 17, wherein the rinsing liquid in the rinsing liquid source comprises DI water.

19. The apparatus according to claim 18, wherein the rinsing liquid further comprises a surfactant that, when mixed with the rinsing liquid, decreases the rinsing liquid surface tension on a hydrophobic surface.

20. The apparatus according to claim 16, wherein the tensioactive vapor in the tensioactive vapor source is nitrogen gas mixed with isopropyl alcohol vapor.

21. The apparatus according to claim 16, wherein the mechanical arm is adapted to sweep in an arc over the workpiece surface during the rinsing process.

22. The apparatus according to claim 16, wherein the second rinsing liquid nozzle is positioned to always dispense nearer to a closest workpiece outer edge than the first rinsing liquid nozzle during the rinsing process.

23. The apparatus according to claim 16, wherein the first rinsing liquid nozzle is the most outwardly positioned nozzle on the mechanical arm and the second rinsing liquid nozzle is the most inwardly positioned nozzle on the mechanical arm.

24. The apparatus according to claim 23, wherein the first rinsing liquid nozzle is positioned to dispense toward an area where the tensioactive vapor nozzle sprays the, workpiece during the rinsing process.

25. The apparatus according to claim 24, wherein the tensioactive vapor nozzle is positioned to spray the workpiece a substantially perpendicular angle with respect to the workpiece surface during the rinsing process.

26. The apparatus according to claim 24, wherein the second rinsing liquid nozzle is positioned to dispense toward an outer edge of the workpiece during the rinsing process.

27. The apparatus according to claim 26, wherein the first and second rinsing liquid nozzles are pointed in directions that in a horizontal plane differ by approximately 90°.

28. The apparatus according to claim 16, wherein the chuck is adapted to have spinning parameters that are controlled independent of any motion parameters for the mechanical arm.

29. A method for rinsing a workpiece surface, comprising the steps of:
dispensing a rinsing liquid onto the workpiece surface using first and second rinsing nozzles while sweeping the rinsing nozzles over at least part of the workpiece surface;
separately and independently controlling rinsing liquid flow rates for each of the first and second rinsing nozzles; and
spraying a tensioactive vapor composition onto an area of the workpiece surface that is simultaneously being rinsed by at least the first rinsing nozzle.

30. The method according to claim 29, further comprising the step of supplying rinsing liquid to the first and second rinsing liquid nozzles from separate rinsing liquid sources.

31. The method according to claim 29, wherein the rinsing liquid comprises DI water.

32. The method according to claim 31, wherein the rinsing liquid further comprises a surfactant that decreases the rinsing liquid surface tension on the hydrophobic surface.

33. The method according to claim 29, wherein the tensioactive composition is nitrogen gas mixed with isopropyl alcohol vapor.

34. The method according to claim 29, wherein the nozzles are swept in an arc over the workpiece surface.

35. The method according to claim 29, wherein the second rinsing liquid nozzle always dispenses nearer to a closest workpiece outer edge than the first rinsing liquid nozzle.

36. The method according to claim 29, wherein the rinsing nozzles are mounted on a mechanical arm that sweeps the nozzles over the workpiece surface, with the first rinsing nozzle being the most outwardly positioned nozzle on the mechanical arm and the second rinsing liquid nozzle being the most inwardly positioned nozzle on the mechanical arm.

37. The method according to claim 29, wherein the tensioactive vapor nozzle sprays the workpiece at a substantially perpendicular angle with respect to the workpiece surface during the rinsing process.

38. The method according to claim 29, wherein the second rinsing liquid nozzle dispenses toward an outer edge of the workpiece during the rinsing process.

39. The method according to claim 29, wherein the first and second rinsing liquid nozzles are pointed in directions that in a horizontal plane differ by approximately 90°.

40. The method according to claim 36, further comprising the step of separately and independently controlling motion parameters for the workpiece and for the mechanical arm.

41. A method for rinsing a workpiece surface, comprising the steps of:
dispensing a rinsing liquid onto the workpiece surface using first and second rinsing nozzles while sweeping the rinsing nozzles over at least part of the workpiece surface; and
using a nozzle that is disposed between the rinsing nozzles, spraying a tensioactive vapor composition onto an area of the workpiece surface that is simultaneously being rinsed by at least the first rinsing nozzle.

42. The method according to claim 41, further comprising the step of separately and independently controlling rinsing liquid flow rates for each of the first and second rinsing nozzles.

43. The method according to claim 41, further comprising the step of supplying rinsing liquid to the first and second rinsing liquid nozzles from separate rinsing liquid sources.

44. The method according to claim 41, wherein the rinsing liquid comprises DI water.

45. The method according to claim 44, wherein the rinsing liquid further comprises a surfactant that decreases the rinsing liquid surface tension on the hydrophobic surface.

46. The method according to claim 41, wherein the tensioactive composition is nitrogen gas mixed with isopropyl alcohol vapor.

47. The method according to claim 41, wherein the nozzles are swept in an arc over the workpiece surface.

48. The method according to claim 41, wherein the second rinsing liquid nozzle always dispenses nearer to a closest workpiece outer edge than the first rinsing liquid nozzle.

49. The method according to claim 41, wherein the rinsing nozzles are mounted on a mechanical arm that sweeps the nozzles over the workpiece surface, with the first rinsing nozzle being the most outwardly positioned nozzle on the mechanical arm and the second rinsing liquid nozzle being the most inwardly positioned nozzle on the mechanical arm.

50. The method according to claim 41, wherein the tensioactive vapor nozzle sprays the workpiece at a substantially perpendicular angle with respect to the workpiece surface during the rinsing process.

51. The method according to claim 41, wherein the second rinsing liquid nozzle dispenses toward an outer edge of the workpiece during the rinsing process.

52. The method according to claim 41, wherein the first and second rinsing liquid nozzles are pointed in directions that in a horizontal plane differ by approximately 90°.

53. The method according to claim 49, further comprising the step of separately and independently controlling motion parameters for the workpiece and for the mechanical arm.
